(19) United States
(12) Patent Application Publication
(10) Pub. No.: US 2025/0188265 A1
(43) Pub. Date: Jun. 12, 2025

(54) RESIN PRODUCT

(71) Applicant: TOYODA GOSEI CO., LTD., Kiyosu-shi (JP)

(72) Inventors: Kenjiro MORIMOTO, Kiyosu-shi (JP); Kenta KOBAYASHI, Kiyosu-shi (JP); Yuji HOTTA, Kiyosu-shi (JP)

(21) Appl. No.: 18/932,766

(22) Filed: Oct. 31, 2024

(30) Foreign Application Priority Data
Dec. 11, 2023 (JP) 2023-208169

(51) Int. Cl. C08L 55/02; C08F 10/06; C25D 3/12; C25D 3/38

(52) U.S. Cl. CPC C08L 55/02; C08F 10/06; C25D 3/12; C25D 3/38

(57) ABSTRACT

A resin product includes a substrate molded from a resin and a coating that covers a surface of the substrate. The coating has an arithmetic mean height Sa of 0.2 μm or more, a skewness Ssk of −1.3 or more, and a maximum valley depth Sv of 5 times to 30 times of the arithmetic mean height Sa.

### TECHNICAL FIELD

The present invention relates to a resin product including a substrate molded from a resin and a coating that covers the surface of the substrate.

### BACKGROUND ART

Foreign matter may be mixed into a resin. In particular, a recycled resin made from a used resin contains a lot of foreign matter such as resins and metals that cannot completely be removed during a separation process. It is possible to increase purity by increasing the level of separation of foreign matter, but there are limits due to increased costs and energy.

On the surface of a substrate molded from a resin containing foreign matter, deep and large local depressions originating from the foreign matter are likely to be formed. These local depressions are easily visible to naked eyes, resulting in a poor appearance such as roughness (see FIG. 1). Therefore, it is necessary to cover the surface of the substrate with a paint coating etc. so that the local depressions are hardly visible to the naked eyes.

Patent Literature 1 discloses an automotive exterior panel. Based on the finding that spots etc. due to roughness of a parison can be reduced by performing blow molding at a predetermined temperature using a mold with fine projections and depressions rather than a mirror-finished mold and applying a coating film having a predetermined thickness corresponding to the surface roughness of the fine projections and depressions, a coating film having a thickness of 120 μm or less is applied to the outer surface of a molded product obtained by blow molding from a predetermined resin, the surface roughness of the molded product is 3 μm to 13.5 μm, and the relationship between the surface roughness of the molded product (H) and the coating film thickness (T) is T≥4.5H+10. When H is 3 μm, T is set to 23.5 μm or more. When H is 13.5 μm, T is set to 70.75 μm or more.

### CITATION LIST

### Patent Literature

[Patent Literature 1] Japanese Unexamined Patent Application Publication No. 2001-009369 (JP 2001-009369 A)

### SUMMARY OF THE INVENTION

### Technical Problem

According to investigations conducted by the inventors, when the coating film having the thickness disclosed in Patent Literature 1 is simply applied to the surface of a substrate having local depressions as shown in FIG. 1 (not mentioned in Patent Literature 1), depressions formed in the coating film reflecting the local depressions may still easily be visible to the naked eyes (see the left and central parts of FIG. 2A). For example, when the surface roughness of a predetermined area including the local depressions of the substrate is 3 μm and it is covered with a paint coating having a thickness of about 50 μm rather than 23.5 μm, there is a possibility that the depressions that are easily visible to the naked eyes are formed in the coating film and a good appearance is not obtained.

Therefore, an object of the present invention is to obtain a resin product that does not have a poor appearance in such a manner that, even if deep and large local depressions originating from foreign matter are present on the surface of a substrate molded from a resin containing the foreign matter, depressions formed in a coating reflecting the local depressions are made unnoticeable and hardly visible to naked eyes.

### Solution to Problem

[1]A resin product including a substrate molded from a resin and a coating that covers a surface of the substrate, in which
the coating has an arithmetic mean height Sa of 0.2 μm or more, a skewness (degree of bias) Ssk of −1.3 or more, and a maximum valley depth Sv of 5 times to 30 times of the arithmetic mean height Sa.
In the above, Sa and Ssk are measured in an area of 258 μm×258 μm that does not include a depression with a valley depth of 5 times or more of Sa.
The maximum valley depth Sv is measured in an area of 646 μm×646 μm that includes a depression with a valley depth of 5 times or more of Sa.
[2] The resin product according to [1], in which the arithmetic mean height Sa is 0.4 μm or more, and the skewness Ssk is −0.21 or more.
[3] The resin product according to [1] or [2], in which the coating has an 850 gloss value of 90 or less.
[4] The resin product according to [1] or [2], in which the coating has an 85° gloss value of 70 or less.
[5] The resin product according to any one of [1] to [4], in which the resin is a recycled resin.
[6] The resin product according to any one of [1] to [5], in which the substrate has a maximum valley depth Sv of 2 μm to 15 μm.
[7] The resin product according to any one of [1] to [6], in which the coating is a plating coating, a paint coating, or a film coating.

### (Actions)

Even if a deep and large local depression originating from foreign matter present in the substrate is reflected in the coating to form a deep depression in the coating with the maximum valley depth Sv of 5 times to 30 times of the arithmetic mean height Sa (see FIG. 1), the deep depression in the coating becomes unnoticeable and hardly visible to naked eyes (see right and left parts of FIG. 2A) because the coating has the arithmetic mean height Sa of 0.2 μm or more and the skewness Ssk of −1.3 or more. Therefore, even if the substrate is molded from a recycled resin containing foreign matter, the depression in the coating is unnoticeable. Thus, the resin product does not have a poor appearance, and can also be applied to a resin product that requires aesthetic design.

When the coating has Sa of less than 0.2 μm as shown in FIG. 3, the deep depression in the coating is noticeable and therefore easily visible to the naked eyes regardless of Ssk. When the coating has Sa of 0.2 μm or more and Ssk of less than −1.3, the deep depression in the coating is noticeable and therefore easily visible to the naked eyes. Such coatings are limited (to samples 16, 17, 19, 20, etc. described below), and therefore selection is difficult.

### Advantageous Effects of Invention

According to the present invention, it is possible to obtain the resin product that does not have a poor appearance in such a manner that, even if deep and large local depressions originating from foreign matter are present on the surface of the substrate molded from the resin containing the foreign matter, depressions formed in the coating reflecting the local depressions are made unnoticeable and hardly visible to naked eyes.

### BRIEF DESCRIPTION OF DRAWINGS

FIG. 1 is a photograph of the surface of a substrate (sample 1) molded from a recycled resin;

FIG. 2A is a conceptual diagram illustrating that depressions in a coating are noticeable in related art and unnoticeable in the present invention;

FIG. 2B is a conceptual diagram illustrating a surface roughness measurement part;

FIG. 3 is a conceptual diagram illustrating that the noticeability of the depressions differs depending on Sa and Ssk of the coating;

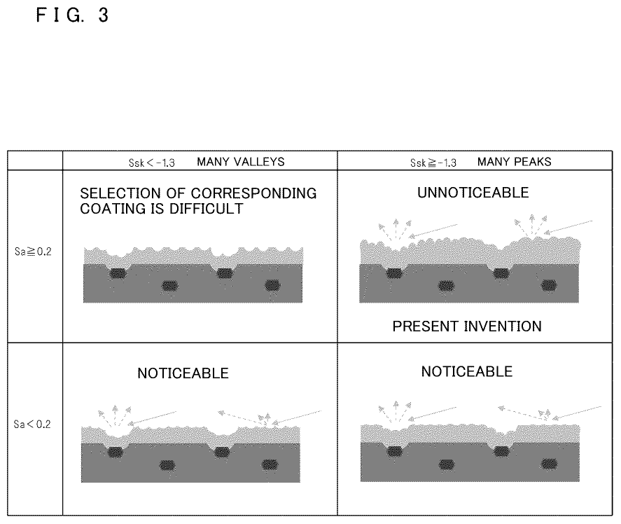

FIG. 4 is a graph plotting Sa and Ssk of samples 1 to 20; and

FIG. 5 is a graph plotting 850 gloss values and appearance scores of samples 1 to 20.

### DESCRIPTION OF EMBODIMENTS

### 1. Substrate

Examples of the resin include, but not particularly limited to, polypropylene (PP), an acrylonitrile-butadiene-styrene copolymer (ABS), polycarbonate (PC), and polyethylene terephthalate (PET).

When the resin is a recycled resin containing foreign matter, the present invention is particularly useful in that the recycled resin can be used without unnecessarily increasing the level of separation of foreign matter, and therefore there is no increase in costs or energy.

### (Range of Foreign Matter)

The foreign matter may be anything that is incompatible with the resin of the substrate, such as polyurethane (PU), nylon, or paint chips (resin, metal).

The size and shape of the foreign matter are not particularly limited, and the foreign matter may have, for example, a longitudinal diameter of 20 μm to 250 μm.

The ratio of the foreign matter is not particularly limited, and may be, for example, 10 vol % or less.

(Range of Local Depression Originating from Foreign Matter)

The size and shape of the local depression are not particularly limited, and the local depression may have, for example, a longitudinal diameter of 40 μm to 450 μm and a maximum valley depth Sv of 2 μm to 15 μm. The present invention is particularly useful when the Sv of the substrate is 5 μm or more, and can also be applied when it is 10 μm to 15 μm.

### (Molding of Substrate)

The molding of the substrate is not particularly limited, and examples thereof include injection molding, blow molding, extrusion molding, vacuum molding, pressure molding, and slush molding.

### 2. Coating

The type of the coating is not particularly limited, and examples thereof include a plating coating, a paint coating, and a film coating.
The material of the plating coating is not particularly limited, and examples thereof include copper, nickel, chromium, and alloys thereof.

The thickness of the plating coating is not particularly limited, and is preferably 5 μm to 100 μm.
The material of the paint coating is not particularly limited, and examples thereof include an acrylic resin, a urethane resin, and a silicone resin.

The thickness of the paint coating is not particularly limited, and is preferably 5 μm to 100 μm.
The material of the film coating is not particularly limited, and examples thereof include PMMA, PC, PP, PVC, PET, and TPU. The thickness of the film coating is not particularly limited, and is preferably 20 μm to 300 μm.

### 3. Other Layers

A primer layer may be provided between the substrate and the coating.

A protective layer may be provided on the coating.

### 4. Resin Product

Examples of the resin product include, but not particularly limited to, an automotive interior component (instrument panel, cowl, console, glove box, door lining, pillar lining, etc.), an automotive exterior component (bumper, radiator grille, fender, emblem), and a home appliance case.

### Examples

As shown in Table 1 below, sample 1 that was only a substrate molded from a recycled resin and samples 2 to 20 that were resin products each including a coating and a substrate molded from a recycled resin were prepared.

TABLE 1

| | | Coating | | Sv | | Sa |
|---|---|---|---|---|---|---|
| Sample | Substrate | Type | Details | [μm] | Ssk | [μm] |
| 1 | Recycled | None | Unprocessed | 9.81 | −1.086 | 0.031 |
| 2 | ABS | Plating | Bright Cu 1 | 3.64 | 2.866 | 0.045 |
| 3 | | coating | Satin Cu 1 | 6.60 | −0.370 | 0.268 |
| 4 | | | Satin Cu 2 | — | 1.010 | 0.617 |
| 5 | | | Satin Cu 3 | — | 0.044 | 0.410 |
| 6 | | | Satin Ni 1 | — | −0.922 | 0.216 |
| 7 | | Paint | Matte 1 | 15.33 | 3.008 | 2.136 |
| 8 | | coating | Matte 2 | — | 0.327 | 0.739 |
| 9 | | | Matte 3 | — | 2.577 | 3.194 |
| 10 | | | Glossy 1 | 1.05 | −0.314 | 0.020 |
| 11 | | | Glossy 2 | — | −0.512 | 0.035 |
| 12 | | | Metallic 1 | 20.59 | 0.476 | 1.503 |
| 13 | Recycled | Paint | Metallic 2 | 21.16 | 0.158 | 1.408 |
| 14 | PP | coating | Metallic 3 | — | −0.203 | 0.824 |
| 15 | | | Metallic 4 | — | −1.287 | 0.727 |
| 16 | | | Metallic 5 | — | −2.193 | 0.281 |
| 17 | | Film | Film 1 | — | −2.186 | 0.117 |
| 18 | | coating | Film 2 | 10.02 | −0.078 | 1.996 |
| 19 | Recycled | Film | Film 3 | — | −2.657 | 1.517 |
| 20 | ABS | coating | Film 4 | — | −2.408 | 0.768 |

| | | | Appearance | |
|---|---|---|---|---|
| Sample | Sv/Sa | Determination | Score | 85° gloss |
| 1 | 316.45 | Poor | 1 | 97.3 |
| 2 | 80.89 | Poor | 1 | 141.0 |
| 3 | 24.63 | Good | 2 | 87.3 |
| 4 | — | Excellent | 3 | 16.3 |
| 5 | — | Excellent | 3 | 34.5 |
| 6 | — | Good | 2 | 85.1 |
| 7 | 7.18 | Excellent | 3 | 2.0 |
| 8 | — | Excellent | 3 | 29.9 |
| 9 | — | Excellent | 3 | 0.5 |
| 10 | 52.50 | Poor | 1 | 97.1 |
| 11 | — | Poor | 1 | 98.0 |
| 12 | 13.70 | Excellent | 3 | 13.0 |
| 13 | 15.03 | Excellent | 3 | 50.0 |
| 14 | — | Excellent | 3 | 67.0 |
| 15 | — | Good | 2 | 82.8 |
| 16 | — | Poor | 1 | 93.0 |
| 17 | — | Poor | 1 | 91.0 |
| 18 | 5.02 | Excellent | 3 | 62.0 |
| 19 | — | Poor | 1 | 97.3 |
| 20 | — | Poor | 1 | 103.0 |

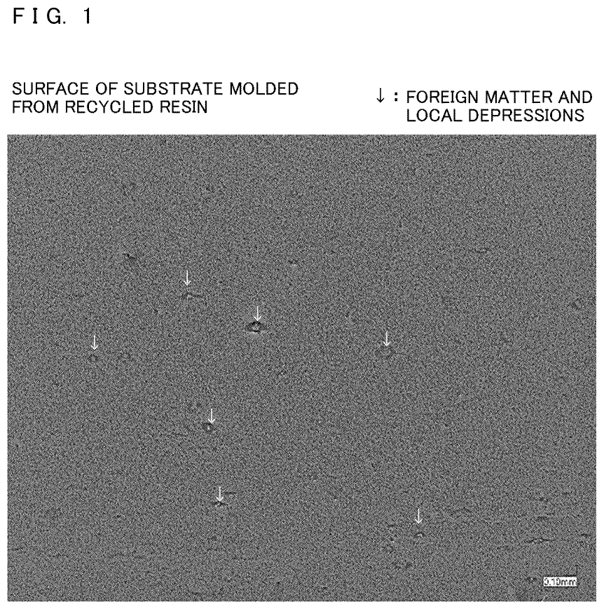

Sample 1 is only a plate-shaped substrate of 60 mm×60 mm×2 mm thick that is obtained by injection molding from recycled ABS. The recycled ABS was prepared by crushing used resin products such as automobiles and home appliances and then separating the ABS from the crushed material by gravity separation, electrostatic separation, etc. FIG. 1 is a photograph of the surface of the substrate of sample 1 having deep and large local depressions originating from foreign matter.

Samples 2 to 6 are each prepared by covering the surface of the same substrate as that of sample 1 with a plating coating.

The plating coating of sample 2 is a bright Cu plating coating formed by electrolytic plating using a bright Cu plating solution such as CU-BRITE EP-30 produced by JCU Corporation. The plating coatings of samples 3 to 5 are satin Cu plating coatings formed by electrolytic plating using a Cu plating solution in a sulfuric acid bath (200 g/L of copper sulfate, 50 g/L of sulfuric acid, 50 g/L of chloride ions) that does not contain a brightener. The surface roughness of the plating coating was adjusted by changing the current density during the electrolytic plating.

The plating coating of sample 6 is a satin Ni plating coating formed by electrolytic plating using a Ni plating solution in a velour-based satin bath.

Samples 7 to 12 are each prepared by covering the surface of the same substrate as that of sample 1 with a paint coating.

The paint coatings of samples 7 to 9 are matte paint coatings formed by spraying a matte appearance paint such as Recrack 30M Black produced by Fujikura Kasei Co., Ltd. The surface roughness of the paint coating was adjusted by changing the thickness of the coating film and the pigment composition.

The paint coatings of samples 10 and 11 are glossy paint coatings formed by spraying a glossy appearance paint such as Soflex 900 Clear produced by Kansai Paint Co., Ltd. The surface roughness of the paint coating was adjusted by the presence or absence of a primer layer.

The paint coating of sample 12 is a metallic paint coating formed by spraying a metallic appearance paint such as Econet PP-100 produced by Origin Co., Ltd.

Samples 13 to 16 are each only a plate-shaped substrate of 60 mm×60 mm×2 mm thick that is obtained by injection molding from recycled PP. The recycled PP was prepared by crushing used resin products such as automobiles and home appliances and then separating the PP from the crushed material by gravity separation, electrostatic separation, etc.

The paint coating of sample 13 is a metallic paint coating formed by the same method as that of sample 12.

The paint coatings of samples 14 to 16 are metallic paint coatings formed by spraying a metallic appearance paint such as Soflex 5800 produced by Kansai Paint Co., Ltd. The surface roughness of the paint coating was adjusted by changing the thickness of the coating film and the composition of luster pigment.

Samples 17 and 18 are each prepared by covering the surface of the same substrate as those used in samples 13 to 16 with a film coating.

The film coating of sample 17 is a film coating formed by bonding a PMMA-based decorative film by heat and pressure bonding. The film coating of sample 18 is a film coating formed by bonding a film similar to that of sample 17 and having a textured surface by heat and pressure bonding.

Samples 19 and 20 are each prepared by covering the surface of the same substrate as that used in sample 1 with a film coating.

The film coating of sample 19 is a film coating formed by bonding a PET-based decorative film by heat and pressure bonding.

The film coating of sample 20 is a film coating formed by the same method as that of sample 17.

For comparison with the recycled resins, sample 21 that was only a substrate molded from a virgin resin and samples 22 to 23 that were resin products each including a coating and a substrate molded from the virgin resin were prepared as shown in Table 2 below.

TABLE 2

| | | Coating | | Sv |
|---|---|---|---|---|
| Sample | Substrate | Type | Details | [μm] |
| 21 | Virgin | None | Unprocessed | 0.51 |
| 22 | ABS | Plating coating | Bright Cu | 0.28 |
| 23 | | Paint coating | Glossy | 0.09 |

Sample 21 is only a plate-shaped substrate of 60 mm×60 mm×2 mm thick that is obtained by injection molding from virgin ABS.
The plating coating of sample 22 is a bright Cu plating coating formed by electrolytic plating using the same Cu plating solution as that of sample 2.
The paint coating of sample 23 is a glossy paint coating formed by the same method as that of sample 10.

The surface roughness and gloss were measured as follows and the appearances were evaluated visually with naked eyes for the substrate of sample 1 and the coatings of samples 2 to 20. The results are shown in Table 1.

The surface roughness (Sv only) was measured as follows for the substrate of sample 21 and the coatings of samples 22 and 23. The results are shown in Table 2.

### <1> Measurement of Surface Roughness

### <1-1> Sa and Ssk

A laser microscope (LEXT OLS4100 manufactured by Olympus Corporation) was used as a measurement device, and Sa and Ssk were measured and calculated under the following measurement and calculation conditions.

### (Measurement Conditions)

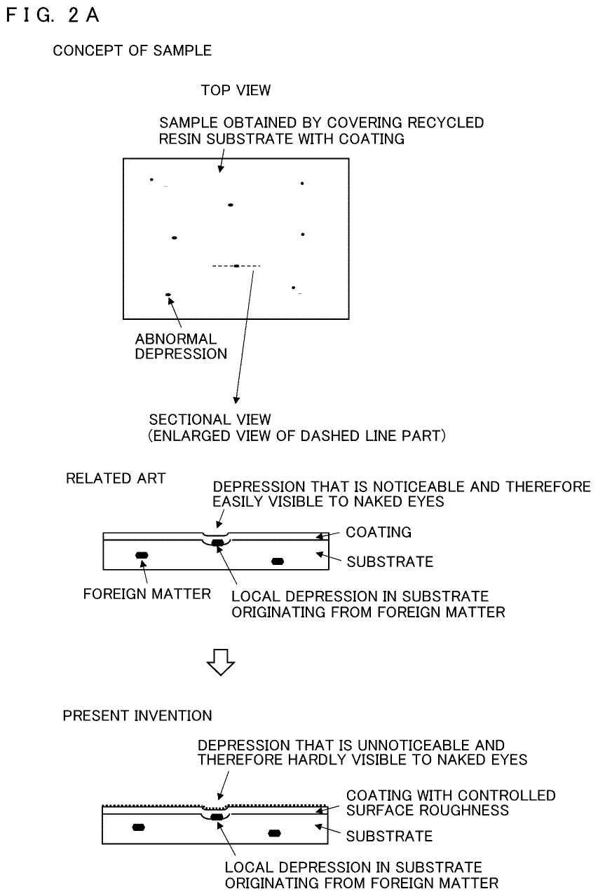

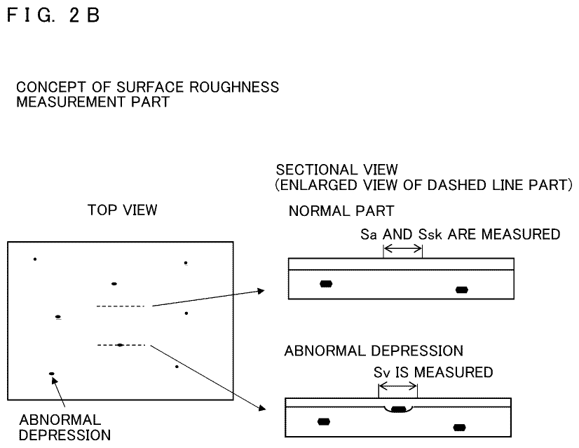

50× objective lens (MPLAPON 50×LEXT, numerical aperture (NA 0.95))
Scanning area: area of 258 μm×258 μm that does not include a depression with a valley depth of 5 times or more of Sa as shown in FIG. 2B (upper sectional view)
Average of three or more measurements per sample

### (Calculation Conditions)

Cutoff: none for λc and λf
Pre-measurement processing: surface correction

### <1-2> Sv

A laser microscope (LEXT OLS4100 manufactured by Olympus Corporation) was used as a measurement device, and Sv was measured and calculated under the following measurement and calculation conditions.

### (Measurement Conditions)

20× objective lens (MPLAPON 20×LEXT, numerical aperture (NA 0.60))
Scanning area: area of 646 μm×646 μm that includes a depression with a valley depth of 5 times or more of Sa as shown in FIG. 2B (lower sectional view)
Average of three or more measurements per sample

### (Calculation Conditions)

Cutoff: none for λc and λf
Pre-measurement processing: surface correction

### <2> Measurement of Gloss (850 Gloss Value)

A gloss measurement device (MULTIGLOSS 268 Plus manufactured by Konica Minolta, Inc.) was used as a measurement device, and gloss (85° gloss value) was measured under the following measurement conditions.

### (Measurement Conditions)

Incident optical axis: 85°
Average of three or more measurements per sample

### (3) Visual Evaluation of Appearance

The samples were visually observed indoors with naked eyes, under fluorescent lights, and at a distance of about 50 cm from the samples, and the presence or absence and severity of defects such as depressions, rough spots, or pits that reflect local depressions originating from foreign matter on the surfaces of the coatings were determined as follows.

### (Determination Conditions)

Excellent: no defects and no problems with appearance
Good: defects partially observed but substantially no problems with appearance
Poor: many defects observed and problems with appearance

### (Appearance Score)

“Excellent” is 3 points, “Good” is 2 points, and “Poor” is 1 point.

### <Considerations>

As shown in Table 2, the substrate of sample 21 molded from the virgin ABS had Sv of 0.51 μm, whereas the substrate of sample 1 molded from the recycled ABS had Sv of 9.81 μm that was significantly larger due to the presence of local depressions originating from foreign matter.

In comparison between samples 22 and 2 obtained by covering these substrates with the bright Cu plating coatings, sample 22 had Sv of 0.28 μm, whereas sample 2 had Sv of 3.64 μm that was significantly larger. In comparison between samples 23 and 10 obtained by covering these substrates with the glossy paint coatings, sample 23 had Sv of 0.09 μm, whereas sample 10 had Sv of 1.05 μm that was significantly larger. This shows that the local depressions in the substrate molded from the virgin ABS were reflected in the depressions in the coating.

Since Sv/Sa of sample 3 is 24.63, it is estimated that Sv/Sa of samples 4 to 6 is within the range of 5 to 30. Since Sv/Sa of sample 7 is 7.18, it is estimated that Sv/Sa of samples 8 and 9 is within the range of 5 to 30. Since Sv/Sa of sample 13 is 15.03, it is estimated that Sv/Sa of samples 14 and 15 is within the range of 5 to 30. Sample 18 has Sv/Sa of 5.02.

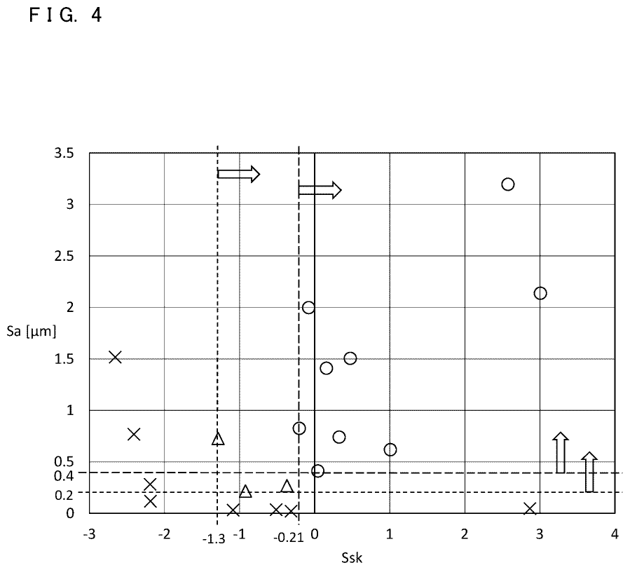

FIG. 4 is a graph plotting Sa and Ssk of samples 1 to 20. The samples in which the coating has Sa of 0.2 μm or more and Ssk of −1.3 or more (samples 3 to 9, 12 to 15, and 18) are evaluated visually with the naked eyes as “Good” or “Excellent” in appearance, and are classified as Examples. The samples in which the coating has Sa of 0.4 μm or more and Ssk of −0.21 or more (samples 4, 5, 7 to 9, 12 to 14, and 18) are particularly preferred because they are evaluated visually with the naked eyes as “Excellent” in appearance.

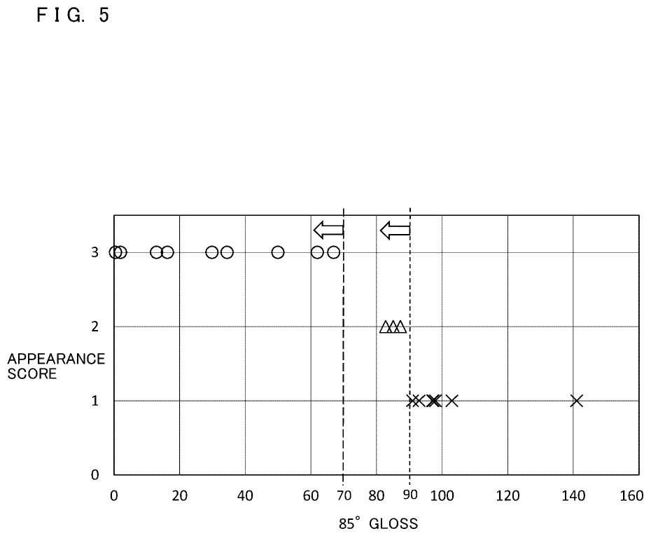

FIG. 5 is a graph plotting 850 gloss values and appearance scores of samples 1 to 20. The samples in which the coating has an 85° gloss value of 90 or less are evaluated visually with the naked eyes as “Good” or “Excellent” in appearance, and the appearance scores are 2 or 3. In particular, the samples in which the coating has an 85° gloss value of 70 or less are preferred because they are evaluated visually with the naked eyes as “Excellent” in appearance and the appearance scores are 3.

The present invention is not limited to the Examples, and can be modified as appropriate without departing from the spirit and scope of the invention.

1. A resin product comprising a substrate molded from a resin and a coating that covers a surface of the substrate, wherein the coating has an arithmetic mean height Sa of 0.2 μm or more, a skewness Ssk of −1.3 or more, and a maximum valley depth Sv of 5 times to 30 times of the arithmetic mean height Sa.

2. The resin product according to claim 1, wherein the arithmetic mean height Sa is 0.4 μm or more, and the skewness Ssk is −0.21 or more.

3. The resin product according to claim 1, wherein the coating has an 850 gloss value of 90 or less.

4. The resin product according to claim 1, wherein the coating has an 85° gloss value of 70 or less.

5. The resin product according to claim 1, wherein the resin is a recycled resin.

6. The resin product according to claim 1, wherein the substrate has a maximum valley depth Sv of 2 μm to 15 μm.

7. The resin product according to claim 1, wherein the coating is a plating coating, a paint coating, or a film coating.
